(19) United States
(12) Patent Application Publication
(10) Pub. No.: US 2002/0091602 A1
(43) Pub. Date: Jul. 11, 2002

(54) System and method for preparation of personal income taxes

(75) Inventors: Edith Helen Stern, Yorktown Heights, NY (US); Sam Dinkin, Austin, TX (US); David Perry Greene, Ossining, NY (US); William Grey, Millwood, NY (US); Paul Andrew Moskowitz, Yorktown Heights, NY (US); Philip Shi-lung Yu, Chappaqua, NY (US)

Correspondence Address: Carstens, Yee & Cahoon, L.L.P., P.O. Box 802334, Dallas, TX, 75380, US

(73) Assignee: International Business Machines Corporation, Armonk, NY (US)

(21) Appl. No.: 09/758,616

(22) Filed: Jan. 11, 2001

(51) Int. Cl. G06F 17/60

(52) U.S. Cl. 705/35

(57) ABSTRACT

The present invention is a system and method that reduces the taxpayer's burden of tax preparation and provides greater accuracy in the calculation of tax return figures. The invention provides for a centralized data repository service which collects tax information on behalf of the citizenry (a financial recording service provider), indexes the data by a personal identifier, and allows the taxpayer to either recall the data for use on yearly income tax returns or enables the government or a third party to access the data, prepare the taxpayer's tax return and file the tax return with the appropriate governmental taxing authority.

### BACKGROUND OF THE INVENTION

1. Technical Field

This invention relates to electronic income tax data processing. More particularly, the invention relates to a system and method for electronically preparing income tax returns by a financial recording service provider which collects and stores tax data and utilizes the stored tax data to assist in the preparation of client taxpayer's income tax returns.

2. Description of Related Art

In recent years taxing authorities at both the federal and state level have increasingly automated tax collection and payment processes. For instance, the United States Internal Revenue Service (IRS) has instituted an electronic tax return filing and refund payment systems which is embodied in the Department of Treasury ACH origination system. However, this system still contains inaccuracies which affect the data provided to the taxing authority.

The IRS tax collection system relies on financial data provided by the individual taxpayer which may or may not, whether intentionally or accidentally, fail to provide pertinent financial data as defined under perpetually evolving IRS laws and regulations. In turn, this leads to the miscalculation of the appropriate tax payment to the taxing authority and, if applicable, tax refund to the taxpayer based on the introduction of incorrect data in the tax return.

With regard to the taxpayer, yearly income tax payment is a difficult process encountered by almost all citizens. During preparation of the tax return, the taxpayer must collect and review many tax records and receipts which were kept, or should have been kept, to substantiate the taxpayer's income and expenditures during the fiscal year. These documents can be voluminous depending on the deductions claimed by the taxpayer.

Business enterprises encounter the same difficulties as individual taxpayers in preparing tax returns. Most businesses generate many records of business income and expenses which are difficult to properly keep and apply to income tax calculation. In some cases, the paper records generated by a business or corporation are so voluminous that they are photographed and placed on microfiche for storage. This process, more often than not, results in the loss of important tax data and increases the difficulty in preparing an accurate tax return which may result in a tax overpayment or underpayment as the case may be.

The present invention recognizes the limitations existing in the prior art and that a need exists for an improved method of gathering tax data from taxpayers and financial, charitable, and retail institutions which enter into transactions with taxpayers, with a greater degree of accuracy. Likewise, the present invention recognizes the need associated with the collection, calculation, payment and refund of tax monies by minimizing the burden placed on the taxpayer to gather and collect the appropriate data required under changing tax statutes.

### SUMMARY OF THE INVENTION

The present invention is a system and method that reduces the taxpayer's burden of tax preparation and provides greater accuracy in the calculation of tax return figures. The invention provides for a centralized data repository service which collects tax information on behalf of the citizenry (a financial recording service provider), indexes the data by a personal identifier, and allows the taxpayer to either recall the data for use on yearly income tax returns or enables the government or a third party to access the data, prepare the taxpayer's tax return and file the tax return with the appropriate governmental taxing authority.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a distributed data processing system in which the present invention may be implemented;

FIG. 2 is a block diagram of a data processing system that may be implemented as a server depicted in accordance with a preferred embodiment of the present invention;

FIG. 3 is a block diagram of a data processing system in which the present invention may be implemented; and,

FIG. 4 is a flowchart depicting one embodiment of the present invention wherein the financial recording service provider communicates with various institutions and receives tax data pertaining to transactions between the client taxpayer and various institutions.

### DETAILED DESCRIPTION OF THE PREFERRED EMBODIMENT

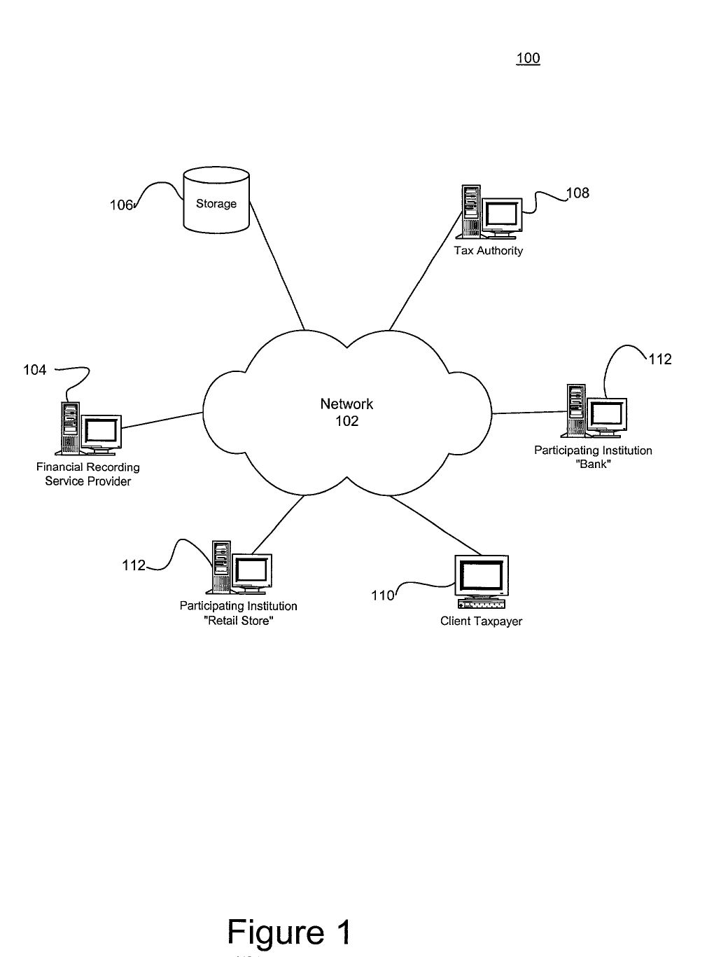

With reference now to the figures, FIG. 1 depicts a pictorial representation of distributed data processing system in which the present invention may be implemented. Distributed data processing system 100 is a network of computers in which the present invention may be implemented. Distributed data processing system 100 contains a network 102, which is the medium used to provide communications links between various devices and computers connected together within distributed data processing system 100. Network 102 includes connections such as wire, fiber optic cables, and telephone connections. In the depicted example, a financial recording service provider 104 is connected to network 102 along with storage 106.

In the depicted example, financial recording service provider 104 represents a third party vendor which provides tax data collection and storage services to client taxpayers, such as client taxpayer at computer 110. Financial recording service provider 104 both transmits and receives data, such as data files, operating systems, images, and applications to and from tax authority 108, client taxpayer 110, and different participating financial institutions 112 which may include banks, brokerage houses, retail stores and charitable organizations, among others. It should be noted that “participating institutions” are those institutions indicated by the client taxpayer's customer profile with the financial recording service provider, which participate in transmitting and receiving tax data with the financial recording service provider. Participating institutions 112 keep electronic records of financial transactions and charitable donations by client taxpayers 110 which may be transmitted to the financial recording service provider 104. The data transmitted to and received by financial recording service provider 104 may be stored locally or on storage medium 106. Tax authority 108 may be a federal, state or local tax authority which accepts electronically transmitted tax information and returns. Distributed data processing system 100 may include additional servers, clients, and other devices not shown.

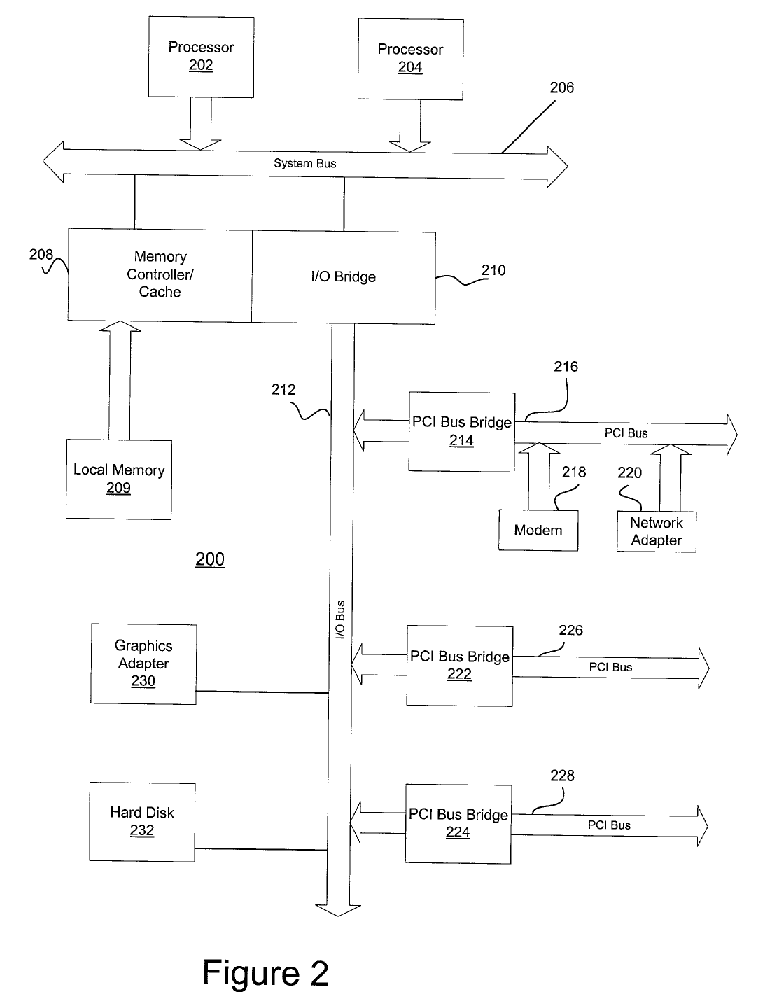

Referring to FIG. 2, a block diagram of a data processing system that may be implemented as a server, such as financial recording service provider 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted. Peripheral component interconnect (PCI) bus bridge 214 connected to I/O bus 212 provides an interface to PCI local bus 216. A number of modems may be connected to PCI bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional Pci bus bridges 222 and 224 provide interfaces for additional PCI buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention. The data processing system depicted in FIG. 2 may be, for example, an IBM RISC/System 6000 system, a product of International Business Machines Corporation in Armonk, N.Y., running the Advanced Interactive Executive (AIX) operating system.

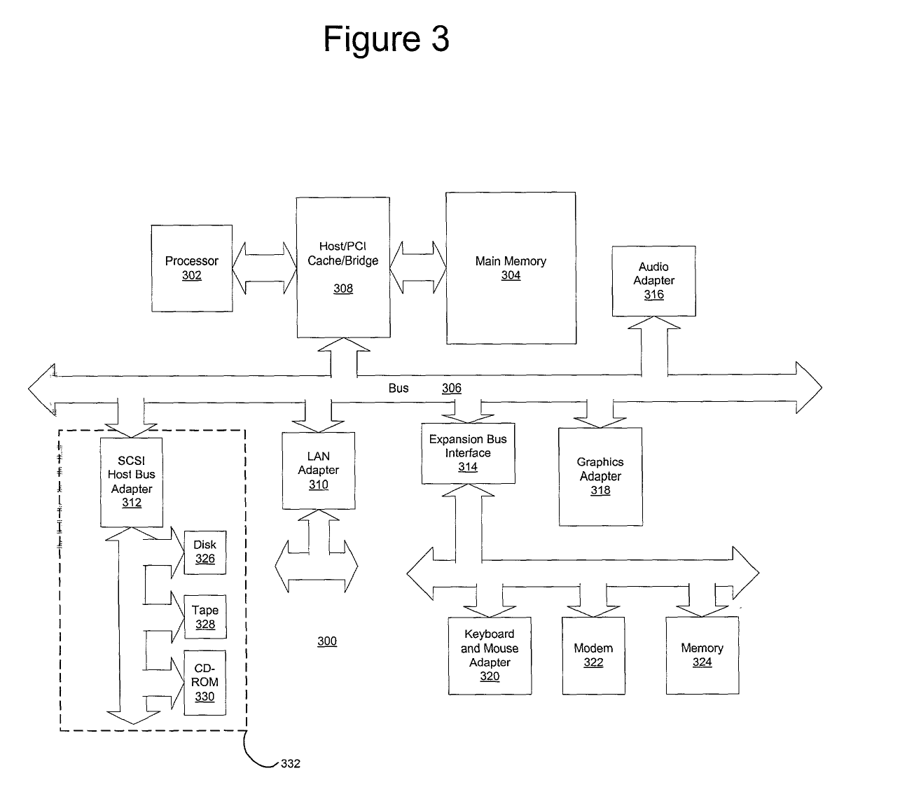

With reference now to FIG. 3, a block diagram illustrating a data processing system is depicted in which the present invention may be implemented. Data processing system 300 is an example of a computer, such as client taxpayer computer 110 in FIG. 1. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316 and graphics adapter 318 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system. As another example, data processing system 300 may be a stand-alone system configured to be bootable without relying on some type of network communication interface, whether or not data processing system 300 comprises some type of network communication interface. The depicted example in FIG. 3 and above-described examples are not meant to imply architectural limitations. For example, data processing system 300 also may be a notebook computer or a device in a black box connected to a power supply system.

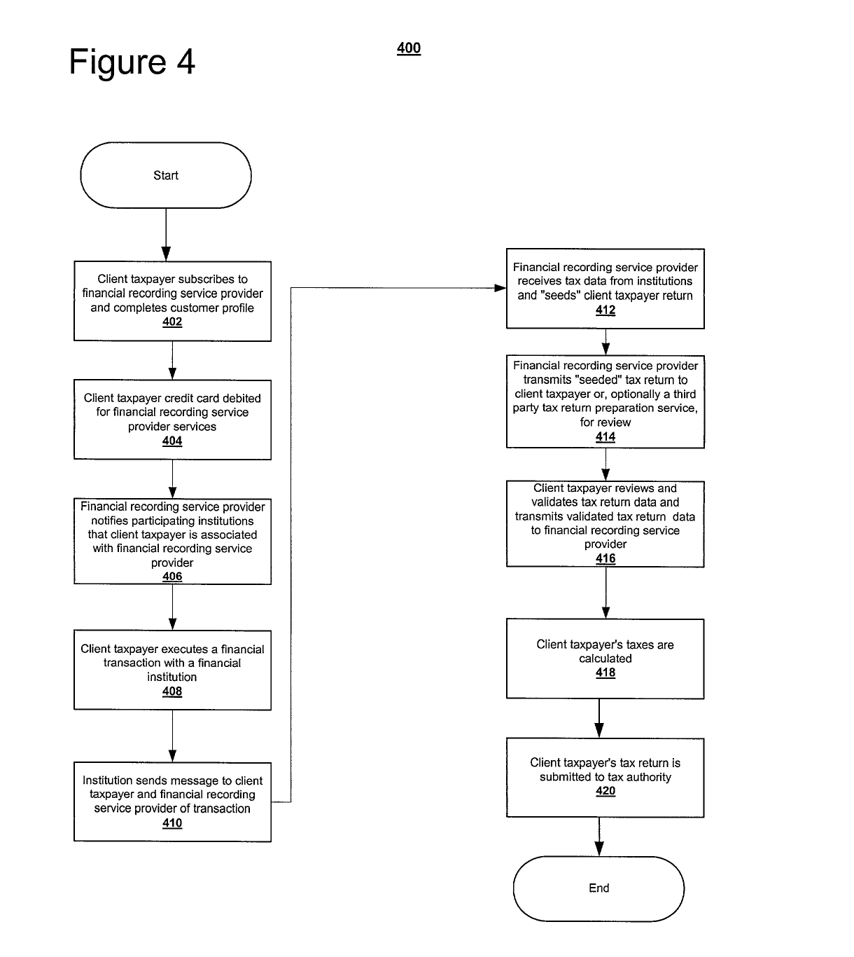

With reference to FIG. 4, a preferred embodiment of the invention is depicted which demonstrates a method of the invention. The client taxpayer registers with a financial recording service provider which provides tax data collection and storage services (Step 402). The client taxpayer fills out an electronic customer profile form that requests pertinent personal and tax data information, including but not limited to, social security number, biographical and earnings information and credit card/debit account information. The data is then transmitted to the financial recording service provider which indexes the information, preferably by taxpayer identification number (e.g. social security number). Next, the client taxpayer's credit card/debit account is debited for the financial recording service provider's service (Step 404). Note that other subscription payment methods may be used (e.g. a yearly bill, a corporate account, etc.) as is generally known in the art. The financial recording service provider notifies participating institutions that the client taxpayer is associated with the financial recording service provider and may transmit tax data to the financial recording service provider after participating institutions consummate transactions with the client taxpayer (Step 406). Optionally, the client taxpayer may notify participating institutions with which he or she does business. The participating institutions may transmit tax data after each transaction, after predefined time periods have elapsed or annually on a predetermined date. Next, the client taxpayer executes transactions with participating institutions which may result in the creation of relevant tax data (Step 408). At the scheduled time, the participating institutions send messages to the client taxpayer and financial recording service provider indicating that a transaction has taken place which has generated tax data (Step 410). Optionally, the participating institutions may send messages to the client taxpayer, and financial recording service provider that tax data generated from transactions with the client taxpayer will be transmitted to the financial recording service provider for inclusion in the client taxpayer's tax return. The financial recording service provider receives the tax data from participating institutions and “seeds” the client taxpayer's tax return with pertinent tax data (Step 412). For example, tax data regarding the dividends from a client taxpayer's stock portfolio/brokerage account at a participating institution are transmitted to the financial recording service provider for insertion (“seeding”) into the client taxpayer's tax return. It should be noted that participating institutions may continue to send to the taxing authority that information required by the tax code.

When tax return preparation is commenced, the financial recording service provider transmits the “seeded” tax return to the client taxpayer, or a third party tax preparation service, for review (Step 414). The client taxpayer, or third party tax preparation service, reviews the “seeded” tax return, and updates the tax data, as needed. The update may include correcting data errors, modifying the tax data, and inserting any additional tax data, if any, to complete the tax return (Step 416). The client taxpayer's taxes are then calculated by the client taxpayer, or, optionally by a third party tax preparation service (Step 418) and then submitted to the appropriate tax authority (Step 420). An electronic copy of the tax data and executed tax return may be sent to the financial recording service provider for storage.

A typical example of the embodiment depicted in FIG. 4 of the invention disclosed herein may be described as follows. A typical taxpayer, John Doe (“Doe”), has moderately complex finances. He has interest bearing bank accounts, an Individual Retirement Account (IRA) (containing both recently contributed money on which the taxes have already been paid, and earlier contributed money on which taxes were not paid as permitted by law at the time), and stock and mutual fund ownership interests. He may also have foreign financial interests, a large home mortgage, and own property in different states. Doe works for a moderately sized company, and sometimes has un-reimbursed business expenses.

A financial recording service provider provides Doe with the service of accumulating his tax information and assisting in the preparation of his tax returns. Doe has subscribed to the financial recording service for the year, and the financial recording service provider (or optionally Doe, individually) has informed all of the financial institutions with which Doe has a relationship that the financial recording service provider is representing Doe (Steps 402, 404, 406).

During the year, financial transactions with tax implications occur involving John (Step 408). The participating institutions inform Doe of the transactions, if he is not party to the transactions directly,(e.g. posting of interest to a bank account, posting of capital gains to a mutual fund) (Step 410). When the transactions involve an institution participating in the financial recording service program, that institution also transmits information about the financial transaction to the financial recording service provider. For example, when a quarterly dividend is posted, the amount of the dividend and the taxpayer ID involved is sent to the financial recording service provider. Optionally, all of the participating institutional data may be sent once a year before taxes are due.

At the end of the fiscal year, tax forms (e.g. 1099-DIV) are generally sent to the taxpayer and to the tax authority by participating institutions, such as mortgage holders, banks, and brokerage houses. In the present invention, this information may also be sent to the financial recording service provider. When Doe is ready to calculate his taxes, his tax data information has already been received by the financial recording service provider and used to “seed” a tax return form for Doe (Step 412). The tax return form “seeded” with the tax data information may be compiled, transmitted and vetted in a variety of ways including, but not limited to, the Internet via a web browser, transmitted as a file for Doe to manipulate on his home computer, and/or printed out by the financial recording service provider and mailed to Doe (Step 414). One of the novel aspects of the invention herein disclosed is that in the inventive system disclosed herein, such “seeding” is done with current year data, rather than the previous year's data as in existing tax preparation systems.

Whatever the format, Doe has line item review and edit for each piece of tax data information. For those institutions which are not “participating” institutions (e.g. foreign stock holdings), Doe inputs the required tax data information for the purposes of updating the tax data, which may include any modifications to the tax data, for completion of the tax form. This update may be performed via entering on a keyboard for a local program, or a server based program, using voice recognition over a telephone to the financial recording service provider, or by hand on a physical form. The tax information is thus updated, completed, validated by the taxpayer (line item edit), and submitted to the appropriate tax authority (Step 416). Submission of the tax return can be accomplished in electronic form from the financial recording service provider, if the financial recording service provider is also providing tax return forms.

The tax data information may then be transmitted to a third party tax return preparation vendor, such as H&R Block, for tax return preparation (Step 418). Likewise, the financial recording service provider function may also include tax return preparation services or may be limited to tax information aggregation on behalf of subscribing taxpayers. The client taxpayer's tax return is then submitted to the tax authority (Step 420).

Another example of an embodiment of the present invention provides for the tax data information relayed to the financial recording service provider to include individual retail transactions as mediated by a charge card company. For example, if a credit card company is a participant to the financial recording service provider, or if the financial recording service provider includes a credit card business, then each charge amount, at or near the time the transaction is completed, can be transmitted to the financial recording service provider with the appropriate tax information. That is, if Doe has an unreimbursed business expense, he can so indicate at the time of charging and that information can be relayed to the financial recording service provider by the charge card company. This allows capture of tax information for itemized deductions.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system. The embodiments described herein were chosen in order to best explain the principles of the invention, the practical application, and to enable others of ordinary skill in the art to understand the invention for various embodiments with various modifications as are suited to the particular use contemplated.

What is claimed is:

1. A method of preparing a tax return comprising the steps of:
subscribing to a financial recording service provider;
receiving tax data from the financial recording service provider;
validating the tax data received from the financial recording service provider; and,
submitting the validated tax data.

2. The method of claim 1 wherein the validated tax data is submitted to a tax authority.

3. The method of claim 1 wherein the validated tax data is submitted to the financial recording service provider.

4. The method of claim 1 wherein the validated tax data is submitted to a tax return preparation service.

5. The method of claim 1 further comprising the step of:
updating the client taxpayer's tax data with additional financial data.

6. A method of preparing a tax return comprising the steps of:
receiving tax data associated with a client taxpayer from an institution;
seeding a tax return with the tax data received from the institution; and,
validating the tax data.

7. The method of claim 6 wherein the client taxpayer may validate the tax data in the tax return.

8. The method of claim 6 further comprising the steps of:
updating the tax data with additional tax data.

9. The method of claim 8 wherein validating the additional tax data is performed by the client taxpayer.

10. The method of claim 8 wherein validating the additional tax data is performed by the financial recording service provider.

11. The method of claim 8 wherein validating the additional tax data is performed by a tax return preparation service.

12. The method of claim 8 wherein validating the additional tax data is performed by the institution.

13. The method of claim 6 further comprising:
billing the client taxpayer subscriber.

14. A system for preparing a tax return comprising:
means for subscribing to a financial recording service provider;
means for receiving tax data from the financial recording service provider;
means for validating the tax data received from the financial recording service provider; and,
means for submitting the validated tax data.

15. The system of claim 14 wherein the validated tax data is submitted to a tax authority.

16. The system of claim 14 wherein the validated tax data is submitted to the financial recording service provider.

17. The system of claim 14 wherein the validated tax data is submitted to a tax return preparation service.

18. The system of claim 14 further comprising:
updating the tax data with additional financial data.

19. A system for preparing a tax return comprising:
means for receiving tax data associated with a client taxpayer from an institution; and,
means for seeding a tax return with the tax data received from the institution.

20. The system of claim 19 wherein the client taxpayer may validate the tax data.

21. The system of claim 19 further comprising:
means for updating the tax data with additional tax data.

22. The system of claim 21 wherein validating the tax data is performed by the client taxpayer.

23. The system of claim 21 wherein validating the tax data is performed by the financial recording service provider.

24. The system of claim 21 wherein validating the tax data is performed by a tax return preparation service.

25. The system of claim 21 wherein validating the tax data is performed by the institution.

26. A method of preparing a tax return, comprising the steps of:
receiving tax data from an institution; and,
indexing the tax data associated with a client taxpayer subscriber.

27. The method of claim 26 further comprising the step of:
selectively providing access to the tax data associated with the client taxpayer subscriber.

28. The method of claim 27 wherein the access to the tax data is provided to an authorized requester.

29. The method of claim 28, wherein the authorized requester is one of the client taxpayer subscriber, a government tax authority, or a third party tax return preparation service.

30. A system for preparing a tax return comprising:
means for receiving tax data from an institution; and,
means for indexing the tax data associated with a client taxpayer subscriber.

31. The system of claim 30 further comprising:
means for selectively providing access to the tax data associated with the client taxpayer subscriber.

32. The system of claim 31 wherein the access to the tax data is provided to an authorized requester.

33. The system of claim 32, wherein the authorized requester is one of the client taxpayer subscriber, a government tax authority, or a third party tax return preparation service.

34. A computer program product for preparing a tax return comprising the steps of:
first instructions for receiving tax data from the financial recording service provider;
second instructions for validating the tax data; and,
third instructions for submitting the validated tax data.

35. The computer program product of claim 34 wherein the validated tax data is submitted to a tax authority.

36. The computer program product of claim 34 wherein the validated tax data is submitted to the financial recording service provider.

37. The computer program product of claim 34 wherein the validated tax data is submitted to a tax return preparation service.

38. The computer program product of claim 34 further comprising:
fourth instructions for updating the tax data with additional financial data.

39. A computer program product for preparing a tax return comprising the steps of:
first instructions for receiving tax data associated with a client taxpayer from an institution;
second instructions for seeding a tax return with tax data received from the institution; and,
third instructions for validating the tax data.

40. The computer program product of claim 39 further comprising:
fourth instructions for submitting the validated tax return to a tax authority.

41. The computer program product of claim 39 wherein the client taxpayer may validate the tax data in the tax return.

42. The computer program product of claim 39 further comprising:
fourth instructions for updating the client taxpayer's tax data with additional tax data; and,
fifth instructions for validating the additional tax data.

43. The computer program product of claim 42 wherein validating the tax data is performed by the client taxpayer.

44. The computer program product of claim 42 wherein validating the tax data is performed by the financial recording service provider.

45. The computer program product of claim 42 wherein validating the tax data is performed by a tax return preparation service.

46. The computer program product of claim 42 wherein validating the tax data is performed by the institution.

47. The computer program product of claim 42 further comprising:
sixth instructions for billing the client taxpayer subscriber.

48. A computer program product for preparing a tax return comprising:
first instructions for receiving tax data from an institution; and,
second instructions for indexing the tax data associated with a client taxpayer subscriber.

49. The computer program product of claim 48 further comprising:
third instructions for selectively providing access to the tax data associated with the client taxpayer subscriber.

50. The computer program product of claim 49 wherein the access to the tax data is provided to an authorized requester.

51. The computer program product of claim 50 wherein the authorized requester is one of the client taxpayer subscriber, a government tax authority, or a third party tax return preparation service.
